(19) United States
(12) Patent Application Publication
(10) Pub. No.: US 2012/0156651 A1
(43) Pub. Date: Jun. 21, 2012

(54) RESTORATION OF ANTERIOR ENDODONTICALLY TREATED TEETH

(76) Inventor: Jack LEVI, Teaneck, NJ (US)

(21) Appl. No.: 13/329,717

(22) Filed: Dec. 19, 2011

Related U.S. Application Data
(60) Provisional application No. 61/425,022, filed on Dec. 20, 2010.

(51) Int. Cl. A61C 5/04

(52) U.S. Cl. 433/224

(57) ABSTRACT

Endodontically treated teeth can be restored with porcelain facial veneer restorations made of Zirconia, IPS emax Ceram layering ceramic and other porcelain materials. The facial and incisal surfaces of teeth are prepared minimally into enamel and the access opening for the root canal, closed with an inlay core preparation and modified post preparation made of the same materials. These give additional support to the clinical crown and prevent fracturing. The modified post is seated into a post barrier material of Super EBA, MTA, or any suitable cement that prevents the egress of moisture or microleakage to the apex of the root canal.

### CROSS-REFERENCE TO RELATED APPLICATION

This patent application is based upon and claims the priority of co-pending, commonly assigned U.S. Provisional Patent Application Ser. No. 61/425,022, filed Dec. 20, 2010, incorporated herein by reference in its entirety.

### FIELD OF THE INVENTION

The disclosed subject matter relates to the restoration of endodontically treated teeth, with porcelain facial veneer restorations.

### BACKGROUND OF THE INVENTION

Endodontics or root canal therapy is that branch of dentistry that deals with the diseases of the dental pulp and periradicular tissues. One aspect of endodontics comprises the treatment of infected root canals by the removal of diseased pulp tissues, using biomechanical cleaning and shaping and subsequent filling of the pulp cavity (root canal). The access opening to the root canal must be sealed and the tooth restored. The objective in root canal therapy is to prevent leakage of toxic products from the root canal system. The placement of the barrier material under the modified post assists in accomplishing this goal.

Root canal therapy is generally indicated for teeth having sound external structures but having diseased, dead, or dying pulp tissues. In such teeth, the pulp tissue and excised portions of the root should be replaced by a biocompatible substitute. The gold standard for filling the root canal is gutta percha and root canal sealer. Micro-leakage from the coronal portion of the tooth can pass through the gutta percha, filling to the apical portion to cause an abscess to form.

One technique for the preparation of a root canal involves creating a coronal straight line access opening with a conventional dental drill. The access opening in this technique is in the shape of an inlay preparation, in the lingual surface of the anterior tooth, to facilitate the pattern withdrawal of the orifice seal and the connected modified post extension. In posterior teeth the access preparation is made through the occlusal tooth surface. A tool is used for gross removal of pulp material from the pulp chamber through the coronal access opening. The canal orifices are located, and the canals are negotiated with narrow files to establish the glide path of the canal. These files are rotated using a balanced force technique until free access to the foramen is reached. Apex locators are used to verify the length of the instrumented canal to the apex. Hand files are used to size #20, and then followed with nickel titanium rotary systems. Debris is removed from the root canal by flushing and evacuation after each instrument use. The root canals are cleansed of all diseased tissue and pulpal remnants. Following chemical antisepsis, the instrumented canal is ready for filling.

Current techniques typically fill the root canal with gutta percha, sealer, or resin. If posts are used, they are either active or passive, metal or fiber. A cosmetic and functional crown made of porcelain fused to metal is usually attached to the post and core. The placement of metal posts can result in perforations or fractures which may contribute to later tooth damage.

### SUMMARY OF THE INVENTION

It is an object of the disclosed subject matter to provide a novel method of restoring anterior and posterior endodontically treated teeth.

It is also an object of the disclosed subject matter to provide a method for restoring anterior and posterior endodontically treated teeth wherein the posterior end of a modified porcelain post is positioned in a cement to prevent microleakage.

It is a further an object of the disclosed subject matter to provide a method for restoring anterior endodontically treated teeth wherein a porcelain veneer is positioned on the labial surface of the tooth.

It is a yet further object of the disclosed subject matter to provide a method for restoring anterior endodontically treated teeth wherein a porcelain access inlay core is positioned at the access opening with a connected modified porcelain post.

It is a yet further object of the disclosed subject matter to provide a kit for restoring anterior teeth after endodontic treatment, said kit comprising:
(1) a formable polymeric member capable of forming a modified post and inlay core impression, such as methyl methacrylate or other impression materials;
(2) a formable polymeric member capable of forming a veneer impression, such as polyvinyl siloxane, PVS, IMPREGUM™ polyether dental impression material, available from 3M, Minneapolis, Minn., or other similar types of impression materials;
(3) cement to prevent microleakage, such as MTA or Super EBA or any suitable cement that prevents the egress of moisture or microleakage to the apex of the root canal;
(4) cement to cement a porcelain modified post and inlay core in position, such as a RelyX™, Ivoclar, or Variolink cement; and
(5) bonding cement to cement a porcelain veneer, such as a RelyX, Ivoclar, or Variolink cement.

It is a yet further object of the disclosed subject matter to provide a method of restoring an anterior tooth after endodontic treatment, comprising:
providing an endodontically treated anterior tooth having labial, incisal, and lingual surfaces, an opening in the lingual surface to a root canal, and gutta percha in the root canal;
removing gutta percha from the root canal to provide a post space for a formable polymeric member in the form of a sprue capable of forming a modified post and inlay core impression;
inserting a polymeric sprue comprising, for example, DURALAY™ (methyl methacrylate), into the root canal to form a modified post and inlay core impression from the root canal;
preparing a modified post and inlay from the formable member, the modified post and inlay core having an apical end and an occlusal end containing the inlay;
injecting a cement barrier, for example, of from about 2 to about 3 mm of MTA or Super EBA cement into the root canal to prevent microleakage;
injecting a second cement capable of bonding the modified post and inlay core to the root canal, such as a RelyX, Ivoclar, or Variolink cement;
inserting the apical end of the modified post and inlay core into the root canal to contact the first and second cements;
smoothing the occlusal end of the modified post and inlay core to be co-extensive with the lingual surface of the tooth;
removing from about 0.2 to about 0.3 mm of enamel from the labial and about 0.2 mm from the incisal surfaces of the tooth to prepare a chamfer to receive the margin outline of the porcelain veneer;
taking an impression of the veneer preparation;
having a lab prepare a temporary plastic veneer with a selected shade until the final veneer is completed;
cementing with spot cementation on the labial preparation;
pumicing off after temporary plastic veneer is removed and permanent veneers are tried into place;
preparing a porcelain veneer from the impression of the veneer preparation; and
cementing the porcelain veneer into the veneer preparation, by isolating the proximal of the tooth with plumber's tape and paper points interproximally.

An anterior tooth is typically treated endodontically by removing the enamel and dentin tooth surfaces, causing a portal in the lingual or occlusal portion of the tooth structure, and removing diseased and/or dead nerve tissue. The root canal is filled with a material such as gutta percha, and the upper portion of the canal is finished to be smooth with the remaining surface. A temporary veneer may be installed.

Intact endodontically treated anterior teeth do not need complete crown coverage unless they are weakened by large and/or multiple coronal restorations. Use of a porcelain facial veneer restoration with minimally invasive preparation, combined with insertion of an access modified post and inlay core, is an alternative to the natural tooth with a composite access seal or to a metallic post core and crown. It is believed that porcelain veneers, such as Zirconia porcelain veneers, will support the clinical crown of an anterior endodontically treated tooth to prevent fracturing. Further support from the lingual surface, using the same material, should give additional backing to the clinical crown. The use of minimal veneer preparation along with a slight lingual wrap minimizes the amount of tooth structure that is removed. The veneer is buttressed by a lingual inlay core/modified post restoration.

According to an embodiment of the disclosed subject matter, about four or five millimeters of the gutta percha of the endodontically treated tooth is removed to form a post space to receive a modified porcelain post. An additional about two to about three millimeters of the gutta percha are removed to accommodate the post barrier cement. The upper portion of the tooth is configured to receive an inlay core. The lingual surface of the tooth is treated to prepare the access for an anterior porcelain inlay core. A modified porcelain post and inlay core is prepared by a dental laboratory, is fitted for insertion and seal of the access preparation, and is cemented into position. The post space is prepared with a “Brasseler Peezo Bur,” or a safety tip peezo. The apical end of the post preparation is round. The post preparation is parallel in design. After being checked for proper insertion and fit, the modified post and inlay core is cemented into the root space preparation. The walls of the post space, and the post and inlay core, are coated with RelyX, Ivoclar, or Variolink cement prior to final insertion for cementation. These cements are beneficial in preventing microleakage and cementing porcelain restorations.

The core is the material that encircles the post after it emerges from the post space preparation into the coronal portion of the tooth. According to the disclosed subject matter, a post has some core material encircling it inside the crown, with an inlay core seal at the access opening on the lingual side of the tooth. All parts are connected and made of porcelain.

In another aspect of the disclosed subject matter, the labial and incisal surfaces of the tooth are treated to prepare a chamfer to receive a porcelain veneer. After an impression is taken and the veneer is made from the impression, the veneer is cemented to the indentation (chamfer preparation).

According to an embodiment of the disclosed subject matter, a cement is used in the lower portion of the root canal as a barrier to microleakage. This cement also provides a stable anchor for a porcelain fabricated post. The porcelain post is used to support the facial tooth and veneer.

The modified post and inlay core and the porcelain veneers are preferably fabricated with the aid of 3-dimensional imaging software. This technology offers anterior tooth restoration that prevents microleakage and reduces stress on the root walls. More particularly, the procedures according to the disclosed subject matter combine existing imaging and fabrication technologies and cements in a novel procedure to restore anterior teeth after root canal. Reproduction of veneers and inlay core with modified post can also be fabricated by using the IPS emax Ceram layering ceramic and other porcelain materials techniques.

The disclosed subject matter may be better implemented with the development of advanced scanning probes that can scan into the root canal. Such scanning probes would be thin enough to scan the inlay core and post preparation. A very thin probe should be developed to capture the image of the post preparation in the root canal space, along with development of software that can read the scans taken and reproduce them in porcelain cutting machines. This will enable the reproduction of the post/inlay core with hardware provided for porcelain reproduction in the office. It would not be necessary to send materials to a laboratory for a direct cast reproduction, resulting in a savings of time and money.

Overall, the technology disclosed and claimed herein is less invasive and requires the removal of less tooth structure than current technology for restoring anterior teeth after endodontic treatment.

In one aspect of the disclosed subject matter, a basic tray or kit comprises Brasseler Laminate Burs Kit, vacuum-formed sten for transportation of putty index, a retraction cord and cord packer, and VPS light body and medium body material. In another aspect for delivery, a basic tray or kit comprises resin cement to cement the veneers anterior and posterior post/inlay Light Cure Type Nexes, Vario Link, finishing burs (Brasseler Laminate Burs Kit), and interproximal serrated strips.

In another aspect of the disclosed subject matter, a kit for restoring anterior teeth after endodontic treatment comprises:

(1) a formable polymeric member capable of making a modified post and inlay core impression; and

(2) a formable polymeric member capable of forming a veneer impression.

In another aspect of a kit of the disclosed subject matter, the formable polymeric member (1) comprises methyl methacrylate.

In another aspect of a kit of the disclosed subject matter, the formable polymeric member (2) comprises polyvinyl siloxane.

In another aspect of a kit of the disclosed subject matter, the kit further comprises cement capable of preventing microleakage.

In another aspect of a kit of the disclosed subject matter, the cement is MTA or Super EBA cement.

In another aspect of a kit of the disclosed subject matter, the kit further comprises cement capable of cementing a porcelain modified post and inlay in position and of cementing a porcelain veneer.

In another aspect of a kit of the disclosed subject matter, the cement is RelyX, Ivoclar, or Variolink cement.

In another aspect of a kit of the disclosed subject matter, the kit further comprises Brasseler abrasive drill bits.

In another aspect of a kit of the disclosed subject matter, the kit further comprises porcelain substrates.

In another aspect of a kit of the disclosed subject matter, a kit for restoring anterior teeth after endodontic treatment comprises:

(1) a formable polymeric member capable of making a modified post and inlay core impression;

(2) a formable polymeric member capable of forming a veneer impression; and

(3) cement capable of preventing microleakage.

In another aspect of the disclosed subject matter, a method of restoring an anterior endodontically treated tooth having labial, incisal, and lingual surfaces comprises:

inserting a formable polymeric member into a root canal to make an impression from the root canal suitable for forming a porcelain modified post and inlay core;

inserting a porcelain modified post and inlay into the root canal;

taking an impression of a modified veneer surface with a formable polymeric member for forming a porcelain veneer; and

cementing the porcelain veneer into the modified veneer surface.

In another aspect of a method of the disclosed subject matter, the method further comprises preparing a porcelain modified post and inlay core from the formable member, the porcelain modified post and inlay core having an apical end and an occlusal end containing an inlay.

In another aspect of a method of the disclosed subject matter, the method further comprises injecting a portion of a first cement into the root canal to form a barrier to prevent microleakage.

In another aspect of a method of the disclosed subject matter, the method further comprises injecting a portion of a second cement into the root canal capable of bonding the modified post and inlay core to the root canal.

In another aspect of a method of the disclosed subject matter, the method further comprises injecting cement into the root canal to form a barrier to prevent microleakage and to bond the modified post and inlay core to the root canal.

In another aspect of a method of the disclosed subject matter, the method further comprises inserting into the root canal a porcelain modified post and inlay core to contact portions of first and second cements.

In another aspect of a method of the disclosed subject matter, the method further comprises smoothing an occlusal end of the modified post and inlay core to be co-extensive with the lingual surface of the tooth.

In another aspect of a method of the disclosed subject matter, the method further comprises removing a portion of the labial and incisal surfaces to create a chamfer to receive the margin outline of the porcelain veneer.

In another aspect of a method of the disclosed subject matter, the method further comprises preparing a temporary plastic veneer with a selected shade until a final veneer is completed.

In another aspect of a method of the disclosed subject matter, the method which further comprises cementing with spot cementation on the labial preparation.

In another aspect of a method of the disclosed subject matter, the method which further comprises pumicing off after a temporary plastic veneer is removed and a permanent veneer is tried into place.

In another aspect of a method of the disclosed subject matter, the method which further comprises preparing a porcelain veneer from the impression of the modified veneer surface.

In another aspect of a method of the disclosed subject matter, the method further comprises cementing the porcelain veneer into the modified veneer surface.

In another aspect of a method of the disclosed subject matter, when the root canal is filled with gutta percha, the method further comprises removing most of the gutta percha from the root canal to provide a post space for a formable polymeric member capable of forming a modified post and inlay core impression.

In another aspect of a method of the disclosed subject matter, the formable polymeric member comprises methyl methacrylate.

In another aspect of a method of the disclosed subject matter, the method further comprises preparing a chamfer by removing from about 0.2 to about 0.3 mm of enamel from the labial surface of the tooth and about 0.2 mm from the incisal surface of the tooth.

In another aspect of a method of the disclosed subject matter, the porcelain veneer is cemented into the veneer preparation by isolating the proximal portion of the tooth with plumber's tape and paper points interproximally.

In another aspect the disclosed subject matter, a method of restoring an anterior endodontically treated tooth having labial, incisal, and lingual surfaces and having a root canal filled with gutta percha and extending from the lingual surface comprises:

removing most of the gutta percha from the root canal to provide a post space for a formable polymeric member capable of forming a modified post and inlay core impression;

inserting a formable polymeric member into the root canal to make an impression from the root canal suitable for forming a porcelain modified post and inlay core;

preparing a porcelain modified post and inlay core from the formable member, the porcelain modified post and inlay core having an apical end and an occlusal end containing the inlay;

injecting cement into the root canal to form a barrier to prevent microleakage and to bond the modified post and inlay core to the root canal;

inserting the porcelain modified post and inlay core into the root canal to contact the cement;

smoothing the occlusal end of the modified post and inlay core to be co-extensive with the lingual surface of the tooth;

removing a portion of the labial and incisal surfaces to create a modified veneer surface with a chamfer to receive the margin outline of a porcelain veneer;

taking an impression of the modified veneer surface;

preparing a temporary plastic veneer with a selected shade until a final porcelain veneer is completed; and

cementing with spot cementation on the labial preparation;

preparing a porcelain veneer from the impression of the veneer preparation;

pumicing off after temporary plastic veneer is removed and the final veneer is tried into place; and

cementing the porcelain veneer into the modified veneer surface.

In another aspect of a method of the disclosed subject matter, a first cement is inserted into the root canal to form a barrier to prevent microleakage.

In another aspect of a method of the disclosed subject matter, the first cement barrier comprises from about 2 to about 3 mm of MTA or Super EBA cement.

In another aspect of a method of the disclosed subject matter, a second cement is inserted to bond the modified post and inlay core to the root canal.

In another aspect of a method of the disclosed subject matter, the second cement comprises RelyX, Ivoclar, or Variolink cement.

In another aspect of a method of the disclosed subject matter, the chamfer is prepared by removing from about 0.2 to about 0.3 mm of enamel from the labial surface of the tooth and about 0.2 mm from the incisal surface of the tooth.

In another aspect of a method of the disclosed subject matter, the porcelain veneer is cemented into the modified veneer surface by isolating the proximal portion of the tooth with plumber's tape and paper points interproximally.

In another aspect of disclosed subject matter, a method of treating a tooth after endodonic treatment comprises inserting into a root canal an effective amount of a cement capable of preventing egress of moisture or microleakage to the apex of the root canal.

In another aspect of a method of the disclosed subject matter, the cement is Super EBA or MTA.

While the technology disclosed and claimed herein primarily pertains to the treatment of anterior endodontically treated teeth, the principles here are also applicable to the treatment of posterior endodontically treated teeth.

### BRIEF DESCRIPTION OF THE DRAWINGS

FIG. 1 is a cross-sectional view of an anterior tooth that has been endodontically treated;

FIG. 2 is a cross-sectional view of the tooth in FIG. 1 where the tooth has been prepared to take an impression;

FIG. 3 is a cross-sectional view of the tooth in FIG. 2 where an impression is being taken; and

FIG. 4 is a cross-sectional view of the tooth of FIG. 3 where the modified post and inlay core and the veneer inlay have been inserted.

### DETAILED DESCRIPTION OF THE DRAWINGS

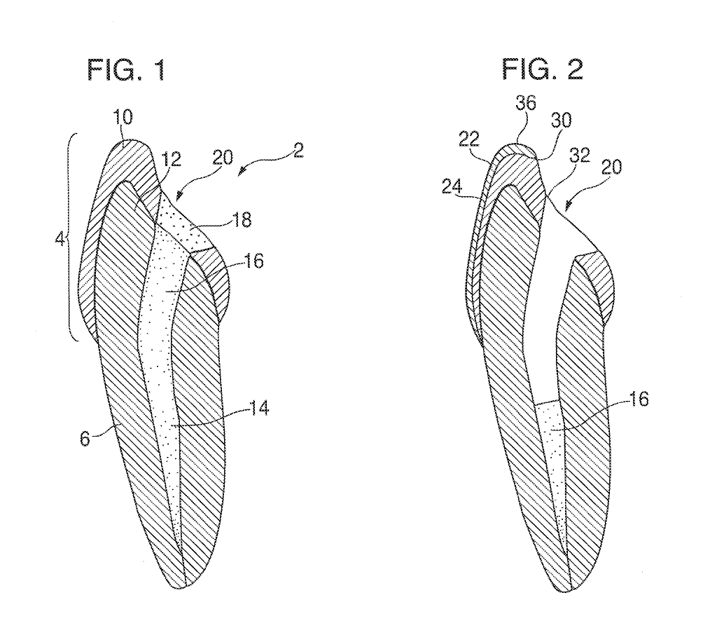

The preferred embodiments of the disclosed subject matter will now be described with reference to FIGS. 1 to 4 of the drawings. Identical elements in the various figures are designated with the same reference numerals.

FIG. 1 illustrates a cross-sectional view of an endodontically prepared anterior tooth prior to further processing. A tooth 2 has a crown 4 and a root 6. Crown 4 comprises enamel 10 and dentin 12. Tooth 2 has a root canal 14 that is filled with gutta percha 16 and cement 18, such as Columbia cement. The cement fills cavity 20.

In the cross-sectional view of FIG. 2, cement 18 and most of gutta percha 16 have been removed from root canal 14. An indentation 22 has been created in enamel 10 on a labial surface 24 and an incisal surface 26, to a depth of from about 0.3 mm to about 0.5 mm. The upper edge 30 of indentation 22 ends approximately about 2 mm to about 3 mm from the upper edge 32 of cavity 20.

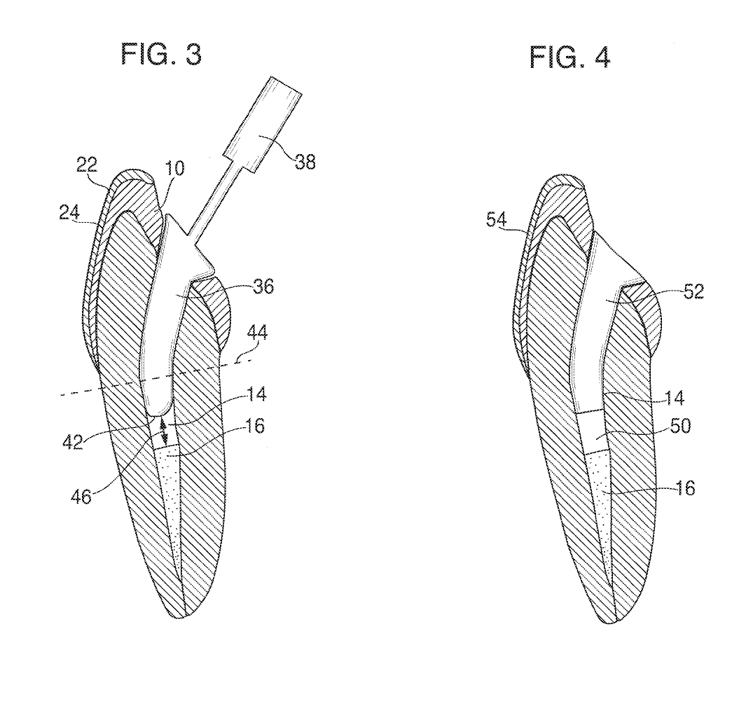

A formable polymeric member 36, which has a sprue 38, is lubricated with a DURALAY™ Tin Lubricant or a petroleum-based lubricant product such as VASELINE 4® petroleum jelly and then inserted into cavity 20 and root canal 14, as shown in FIG. 3. The impression material is withdrawn slowly and reinserted to prevent permanent locking. Once polymeric member 36 hardens, it is used to form a modified post and inlay core in a separate step. In one aspect of the invention, a modified post and inlay core is prepared using CEREC 3-D software, as described more below.

The apical end 42 of polymeric member 36 is positioned (for example, by X-ray) about 2 mm to about 3 mm below the cervical portion of the tooth (collar of the tooth) 44 between enamel 10 and root 6. There is a gap 46 in root canal 14 of about 2 mm between apical end 42 and the remaining gutta percha 16.

A formable member (not shown) is also used to form a veneer to fill indentation 22. The final porcelain veneer, with lingual support members, is formed, for example, using CEREC 3-D software.

To prepare a final tooth according to the disclosed subject matter, cement 50 to prevent microleakage is injected or inserted into the 2-3 mm open space proximal to the gutta percha in the root canal 14, as shown in FIG. 4. Proximal to cement 50 a modified post and inlay core 52 has been cemented into root canal 14. Also, a veneer 54 has been cemented into indentation 22.

The facial and incisal surfaces of teeth are prepared minimally into enamel and the access opening for the root canal, closed with an inlay core preparation and modified post preparation made of the same materials. These give additional support to the clinical crown and prevent fracturing. The modified post is seated into a post barrier material of Super EBA, MTA, or any suitable cement that prevents the egress of moisture or microleakage to the apex of the root canal.

According to the disclosed subject matter, the modified post and inlay core and the labial veneer member are prepared from suitable porcelain, preferably Zirconia porcelain. This porcelain can comprise Zirconia oxide, yttrium oxide, and cerium oxide. Other suitable porcelain materials such as IPS emax Ceram layering ceramic can also be used.

Various cements are useful according to the disclosed subject matter. A particularly important cement is the one that is injected into the root canal space apical to the terminus of the modified porcelain post to prevent the egress of moisture, that is, microleakage, into the root canal. Suitable cements for this purpose include Super EBA available from Bosworth or mineral trioxide aggregate (MTA), available from Dentsply. Other cements that prevent the egress of moisture or microleakage can be substituted. These cements have been clinically proven to be successful apical sealers in apicoectomy, surgical procedures. Prior to cementation, the post space barrier cement is inserted into the root canal space with a syringe. Any suitable carrier can also be substituted to place the cement barrier into the root canal.

Other cements or bonding agents are useful to cement the modified post and inlay include, but are not limited to, RelyX (from 3M), Ivoclar, and Variolink.

Preparation of the indentation for the porcelain veneer is preferably accomplished with diamond Brasseler burs. The burs are applied to the labial (front surface) and incisal surfaces of an anterior tooth to prepare a reduction of enamel that is uniformly from about 0.3 to about 0.5 mm deep on the labial surface and about 0.5 mm deep on the incisal surface. This allows space for the porcelain. Caution must be applied not to cut through to the enamel surface of the tooth. A sharply demarcated chamfer (edge or groove) is prepared on the proximals, gingival margin, and at the terminus of the incisal preparation on the lingual side of the tooth. This permits the wrap around of the porcelain over the incisal to the lingual side of the tooth. The edge or groove (chamfer) defines the enamel reduction. The veneer is prepared from PVS (polyvinyl siloxane) impressions of the tooth. This impression is sent to a dental laboratory to prepare the temporary and final veneers. Teeth may be left uncovered or covered with temporary restorations until the final veneer has been fabricated. The final porcelain veneer can also be formed in the dental office from a hard solid porcelain block using a three-dimensional software, (CEREC) acronym for Chair side Economical Restoration of Esthetic Ceramics, such as described above. The prepared tooth can be restored in a single visit appointment with no need to construct temporaries.

A polymeric form is inserted into the root canal to form an impression to be used to prepare the modified post and inlay core. There are a number of polymeric materials that are known to be useful for this purpose. A preferred material is DURALAY™ polyacrylic resin, available from Reliance Dental Mfg. Co., of Alsip, Ill.

### A Study Applying the Disclosed Subject Matter to Extracted Human and Plastic Model Teeth

The purpose was to construct an alternative model restoration for an anterior endodontically treated tooth. By constructing a minimal veneer preparation of about 0.5 mm or less, with a slight lingual wrap, the intent is to reduce the amount of tooth structure and restore it with a strong porcelain veneer. It would be buttressed by a lingual inlay core/modified post restoration to prevent the shearing of the clinical crown at the cervical.

Materials and Method: A total of twenty-four root canal treated anterior teeth were instrumented, filled with gutta percha and sealer, and prepared minimally for facial veneers. Gutta percha was removed from the root canal space to allow for modified post placement and post space barrier. A post space preparation was made using a Brasseler Para Post non-end cutting, domed shaped peezo bur. Super EBA cement and MTA cement were used as the post space barrier material. Previous microleakage studies showed these materials to be resistant to the penetration of microleakage.

Of the twenty-four teeth, sixteen teeth were plastic typodont, and eight were extracted human anterior teeth. Brasseler depth cut burs were used to remain in enamel and reduce only enough tooth structure so that approximately 0.3-0.5 mm of labial enamel and 0.5 mm of incisal enamel was removed. Twenty-four teeth were prepared for an inlay core access with a modified post preparation of approximately 3 mm. A pattern of the inlay core and modified post was constructed from DURALAY™ polyacrylic. Three Zirconia-like modified post and inlay core restorations were fabricated directly, each tooth using CEREC 3-D Software, which is WINDOWS®-based and three-dimensional. Unlike other restorative methods, this procedure provides maximum control and vision, allowing views of the preparation from all angles.

The CEREC 3-D software is available from Sirona Dental Systems. According to MobileTekLabs, the procedure for constructing a porcelain facial veneer with the CEREC 3-D software is as follows:

Step 1: Start a new restoration.

Step 2: Choose Veneer mode (an anterior tooth must be chosen in order to utilize Veneer mode).

Step 3: Powder the cavity of the tooth.

Step 4: Take an unobstructed image of the cavity; press the green arrow.

Step 5: There is no need to trim the image; press the green arrow.

Step 6: Mark the margin; press the green arrow.

Step 7: A veneer outlined in green will appear. The green outline needs to be the same shape as the margin. Adjust the green line incrementally until it is the same shape as the margin. The final shape needs to be slightly smaller in diameter then the margin; press the green arrow.

Step 8: Use the form tool to apply 1 mm of material to the surface of the restoration (this will ensure the sprue is placed in an optimal position); press the green arrow.

Step 9: Mill the restoration.

Six porcelain facial veneers were constructed from the CEREC 3D software In another procedure, the DURALAY™ impression of the inlay core and modified post impression is sent to a lab where an E Max Porcelain casting can be made and the porcelain reproduction returned for cementation.

Three millimeters of gutta-percha were removed for the post space preparation, and an additional 2 mm were removed for the Super EBA post barrier material. MTA cement was also used as a barrier cement material.

The porcelain facial veneer, and porcelain inlay core with modified post were cemented using Ivoclar or Variolink cement. Any suitable cement for veneer cementation can be substituted. The modified post is placed to imprint itself into the barrier material. This procedure can be checked with a radiograph prior to final cementation.

### RESULTS AND CONCLUSIONS

Although stress tests were not conducted in this study, a review of the literature would support the use of Zirconia-like porcelain veneers to be a useful alternative in restoring endodontically treated teeth. Zirconia's superior strength as a restorative material lends itself to be used without removing excess tooth structure. The replacement of cast and prefabricated metal posts which lead to micro fractures and failures with Zirconia-like porcelain is a plausible alternative. This is a first time presentation of using porcelain facial veneer restorations supported by a lingual inlay core and modified post with endodontically treated teeth. A similar application to this procedure can be applied to posterior teeth with the inlay core/modified post on the occlusal access preparation of endodontically treated teeth.

While various descriptions of the present invention are described above, it should be understood that the various features can be used singly or in any combination thereof. Therefore, the invention is not to be limited to only the specifically preferred embodiments depicted herein. Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. All such modifications, variations and other uses and applications which do not depart from the spirit and scope of the invention are deemed to be covered by the invention, which is defined as set forth in the claims which follow.

What is claimed:

1. A kit for restoring anterior teeth after endodontic treatment, said kit comprising:
(1) a formable polymeric member capable of making a modified post and inlay core impression; and
(2) a formable polymeric member capable of forming a veneer impression.

2. The kit of claim 1, wherein the formable polymeric member (1) comprises methyl methacrylate.

3. The kit of claim 1, wherein the formable polymeric member (2) comprises polyvinyl siloxane.

4. The kit of claim 1 which further comprises cement capable of preventing microleakage.

5. The kit of claim 4, wherein the cement is MTA or Super EBA cement.

6. The kit of claim 1 which further comprises cement capable of cementing a porcelain modified post and inlay in position and of cementing a porcelain veneer.

7. The kit of claim 6, wherein the cement is RelyX, Ivoclar, or Variolink cement.

8. The kit of claim 1 which further comprises Brasseler abrasive drill bits.

9. The kit of claim 1 which further comprises porcelain substrates.

10. A kit for restoring anterior teeth after endodontic treatment, said kit comprising:
(1) a formable polymeric member capable of making a modified post and inlay core impression;
(2) a formable polymeric member capable of forming a veneer impression; and
(3) cement capable of preventing microleakage.

11. The kit of claim 10, wherein the formable polymeric member (1) comprises methyl methacrylate.

12. The kit of claim 10, wherein the formable polymeric member (2) comprises polyvinyl siloxane.

13. The kit of claim 10, wherein the cement is MTA or Super EBA cement.

14. The kit of claim 10 which further comprises a cement capable of cementing a porcelain modified post and inlay in position and of cementing a porcelain veneer.

15. The kit of claim 14, wherein the cement is RelyX, Ivoclar, or Variolink cement.

16. The kit of claim 10 which further comprises Brasseler abrasive drill bits.

17. The kit of claim 10 which further comprises porcelain substrates.

18. A method of restoring an anterior endodontically treated tooth having labial, incisal, and lingual surfaces, which method comprises:
inserting a formable polymeric member into a root canal to make an impression from the root canal suitable for forming a porcelain modified post and inlay core;
inserting a porcelain modified post and inlay into the root canal;
taking an impression of a modified veneer surface with a formable polymeric member for forming a porcelain veneer; and
cementing the porcelain veneer into the modified veneer surface.

19. The method of claim 18 which further comprises preparing a porcelain modified post and inlay core from the formable member, the porcelain modified post and inlay core having an apical end and an occlusal end containing an inlay.

20. The method of claim 18 which further comprises injecting a portion of a first cement into the root canal to form a barrier to prevent microleakage.

21. The method of claim 18 which further comprises injecting a portion of a second cement into the root canal capable of bonding the modified post and inlay core to the root canal.

22. The method of claim 18 which further comprises injecting cement into the root canal to form a barrier to prevent microleakage and to bond the modified post and inlay core to the root canal.

23. The method of claim 18 which further comprises inserting into the root canal a porcelain modified post and inlay core to contact portions of first and second cements.

24. The method of claim 18 which further comprises smoothing an occlusal end of the modified post and inlay core to be co-extensive with the lingual surface of the tooth.

25. The method of claim 18 which further comprises removing a portion of the labial and incisal surfaces to create a chamfer to receive the margin outline of the porcelain veneer.

26. The method of claim 18 which further comprises preparing a temporary plastic veneer with a selected shade until a final veneer is completed.

27. The method of claim 18 which further comprises cementing with spot cementation on the labial preparation.

28. The method of claim 18 which further comprises pumicing off after a temporary plastic veneer is removed and a permanent veneer is tried into place.

29. The method of claim 18 which further comprises preparing a porcelain veneer from the impression of the modified veneer surface.

30. The method of claim 18 which further comprises cementing the porcelain veneer into the modified veneer surface.

31. The method of claim 18 which, when the root canal is filled with gutta percha, further comprises removing most of the gutta percha from the root canal to provide a post space for a formable polymeric member capable of forming a modified post and inlay core impression.

32. The method of claim 18, wherein the formable polymeric member comprises methyl methacrylate.

33. The method of claim 18 which further comprises preparing a chamfer by removing from about 0.2 to about 0.3 mm of enamel from the labial surface of the tooth and about 0.2 mm from the incisal surface of the tooth.

34. The method of claim 18, wherein the porcelain veneer is cemented into the veneer preparation by isolating the proximal portion of the tooth with plumber's tape and paper points interproximally.

35. A method of restoring an anterior endodontically treated tooth having labial, incisal, and lingual surfaces and having a root canal filled with gutta percha and extending from the lingual surface, which method comprises:
removing most of the gutta percha from the root canal to provide a post space for a formable polymeric member capable of forming a modified post and inlay core impression;
inserting a formable polymeric member into the root canal to make an impression from the root canal suitable for forming a porcelain modified post and inlay core;
preparing a porcelain modified post and inlay core from the formable member, the porcelain modified post and inlay core having an apical end and an occlusal end containing the inlay;
injecting cement into the root canal to form a barrier to prevent microleakage and to bond the modified post and inlay core to the root canal;
inserting the porcelain modified post and inlay core into the root canal to contact the cement;
smoothing the occlusal end of the modified post and inlay core to be co-extensive with the lingual surface of the tooth;
removing a portion of the labial and incisal surfaces to create a modified veneer surface with a chamfer to receive the margin outline of a porcelain veneer;
taking an impression of the modified veneer surface;
preparing a temporary plastic veneer with a selected shade until a final porcelain veneer is completed; and
cementing with spot cementation on the labial preparation;
preparing a porcelain veneer from the impression of the veneer preparation;
pumicing off after temporary plastic veneer is removed and the final veneer is tried into place; and
cementing the porcelain veneer into the modified veneer surface.

36. The method of claim 35, wherein the formable polymeric member comprises methyl methacrylate.

37. The method of claim 35, wherein a first cement is inserted into the root canal to form a barrier to prevent microleakage.

38. The method of claim 37, wherein the first cement barrier comprises from about 2 to about 3 mm of MTA or Super EBA cement.

39. The method of claim 35, wherein a second cement is inserted to bond the modified post and inlay core to the root canal.

40. The method of claim 39, wherein the second cement comprises RelyX, Ivoclar, or Variolink cement.

41. The method of claim 35, wherein the chamfer is prepared by removing from about 0.2 to about 0.3 mm of enamel from the labial surface of the tooth and about 0.2 mm from the incisal surface of the tooth.

42. The method of claim 35, wherein the porcelain veneer is cemented into the modified veneer surface by isolating the proximal portion of the tooth with plumber's tape and paper points interproximally.

43. A method of treating a tooth after endodonic treatment, which comprises inserting into a root canal an effective amount of a cement capable of preventing egress of moisture or microleakage to the apex of the root canal.

44. The method of claim 43, wherein the cement is Super EBA or MTA.
